(19) United States
(12) Patent Application Publication
(10) Pub. No.: US 2007/0091589 A1
(43) Pub. Date: Apr. 26, 2007

(54) BACKLIGHT ASSEMBLY AND DISPLAY DEVICE HAVING THE SAME

(75) Inventors: Jae-Min CHOI, Asan-si (KR); Jae-Hwan CHUN, Suwon-si (KR); Jong-Ho WON, Suwon-si (KR); Hyun-Chul JEONG, Asan-si (KR)

Correspondence Address: CANTOR COLBURN, LLP, 55 GRIFFIN ROAD SOUTH, BLOOMFIELD, CT, 06002, US

(73) Assignee: SAMSUNG ELECTRONICS CO., LTD, Suwon-si (KR)

(21) Appl. No.: 11/550,847

(22) Filed: Oct. 19, 2006

(30) Foreign Application Priority Data
Oct. 20, 2005 (KR) 1020050098961
Nov. 2, 2005 (KR) 1020050104074

(51) Int. Cl. G09F 13/04

(52) U.S. Cl. 362/97

(57) ABSTRACT

A backlight assembly includes a receiving container, a plurality of lamps and a lamp support member. The receiving container includes a bottom portion and a side portion defining a receiving space. The lamps are arranged substantially in parallel with each other in the receiving container and generate light. The lamp support member is disposed in the receiving container. The lamp support member includes a support lamp ring supporting the lamp and a support plate coupled to the support lamp ring fixing the support lamp ring.

This application claims priority to Korean Patent Application No. 2005-98961 filed on Oct. 20, 2005 and Korean Patent Application No. 2005-104074 filed on Nov. 2, 2005, and all the benefits accruing therefrom under 35 U.S.C. §119, the contents of which are herein incorporated by reference in their entireties.

### BACKGROUND OF THE INVENTION

1. Field of the Invention

The present invention relates to a backlight assembly and a display device having the backlight assembly. More particularly, the present invention relates to a backlight assembly capable of improving display quality and a display device having the backlight assembly.

2. Description of the Related Art

Generally, a liquid crystal display (LCD) device displays images using electrical characteristics and optical characteristics of the liquid crystal. The LCD device has advantageous characteristics such as a thin thickness, a light weight, a low driving voltage, a low power consumption, etc. Thus, the LCD device is widely used in various fields.

The LCD device includes a LCD panel displaying images using an optical transmissivity of the liquid crystal and a backlight assembly providing light to the LCD panel.

The backlight assembly employed in the LCD device is classified into either an edge illumination type backlight assembly or a direct illumination type backlight assembly by a criterion of position of a light source included in the backlight assembly.

The edge illumination type backlight assembly includes a lamp generating light, a light guiding plate disposed at a side of the lamp and a receiving container receiving the lamp and the light guiding plate. In the edge illumination type backlight assembly, the light guiding plate guides the light provided from a side face of the light guiding plate, and then exits the guided light to the LCD panel.

The direct illumination type backlight assembly includes a plurality of lamps disposed under the LCD panel, a receiving container receiving the lamps, a light-diffusing plate disposed over the lamps and a light-reflecting plate disposed under the lamps. In the direct illumination type backlight assembly, light generated from the lamps diffuses through the light-diffusing plate, and then is incident into the LCD panel.

The direct illumination type backlight assembly further includes a lamp support member supporting the lamps. Since each lamp typically has a cylindrical shape, the lamp support member has a U-shape so as to partially enclose the lamp. When the lamp support member partially encloses the lamp, the lamp support member makes contact with a large portion of the lamp.

However, when the lamp support member makes contact with a large portion of the lamp, heat generated from the lamp is transferred to the lamp support member through the contact portion of the lamp. Thus, temperature of the contact portion of the lamp decreases, thereby forming a dark portion of the LCD device, which is externally viewable. As a result, display quality of the LCD device is deteriorated due to the dark portion.

### BRIEF SUMMARY OF THE INVENTION

An exemplary embodiment provides a backlight assembly capable of reducing an amount of heat transfer to improve display quality of images.

An exemplary embodiment provides a display device having the above-mentioned backlight assembly.

In an exemplary embodiment, a backlight assembly includes a receiving container, a plurality of lamps and a lamp support member.

The receiving container includes a bottom portion and a side portion defining a receiving space. The lamps are arranged substantially in parallel with each other in the receiving container and generate light. The lamp support member is disposed in the receiving container. The lamp support member includes a support lamp ring supporting the lamp and a support plate coupled to the support lamp ring and fixing the support lamp ring.

In an exemplary embodiment, the receiving container includes a bottom portion and a side portion to define a receiving space. The lamps are arranged substantially in parallel with each other in the receiving container and generate light. The lamp support member is disposed in the receiving container. The lamp support member includes a support body portion crossing the lamp, and a lamp ring portion protruding from the support body portion and having a ring shape to enclose the lamp.

In an exemplary embodiment, a display device includes a backlight assembly and a display panel.

The backlight assembly includes a receiving container, a plurality of lamps and a lamp support member. The receiving container includes a bottom portion and a side portion to define a receiving space. The lamps are arranged substantially in parallel with each other over the bottom portion of the receiving container and generate light. The lamp support member is coupled to the bottom portion of the receiving container and fixes the lamps. The lamp support member includes a support lamp ring enclosing and supporting the lamp and a support plate coupled to the support lamp ring and fixing the support lamp ring. The display panel is disposed over the backlight assembly and displays images using the light provided from the backlight assembly.

In an exemplary embodiment, a lamp is partially supported by a lamp support member, so that the lamp and the lamp support member make relatively small contact with each other. Luminance non-uniformity due to decrease in local temperature of the lamp may be reduced or effectively prevented, thereby improving display quality of images of a display device having the lamp support member.

### BRIEF DESCRIPTION OF THE DRAWINGS

The above and other features and advantage points of the present invention will become more apparent by describing in detailed example embodiments thereof with reference to the accompanying drawings, in which:

FIG. 1 is an exploded perspective view illustrating an exemplary embodiment of a backlight assembly according to the present invention;

FIG. 2 is a cross-sectional view taken along line I-I′ in FIG. 1;

FIG. 3 is an enlarged view of portion ‘A’ in FIG. 2;

FIG. 4 is a perspective view illustrating an exemplary embodiment of the lamp support member of the backlight assembly illustrated in FIG. 1;

FIG. 5 is an exploded perspective view illustrating the lamp support member illustrated in FIG. 4;

FIG. 6 is an exploded perspective view illustrating a rear surface of the support lamp ring of the lamp support member illustrated in FIG. 5;

FIG. 7 is a cross-sectional view illustrating another exemplary embodiment of a lamp support member of a backlight assembly according to the present invention;

FIG. 8 is an enlarged view of portion ‘B’ in FIG. 7;

FIG. 9 is a perspective view illustrating another exemplary embodiment of a lamp support member of a backlight assembly according to the present invention;

FIG. 10 is a rear perspective view illustrating the support plate illustrated in FIG. 9;

FIG. 11 is a side view illustrating the support lamp ring illustrated in FIG. 9;

FIG. 12A and FIG. 12B are perspective views illustrating an exemplary embodiment of a method of coupling the support plate and the support lamp ring illustrated in FIG. 9; and

FIG. 13 is an exploded perspective view illustrating an exemplary embodiment of a display device according to the present invention.

### DETAILED DESCRIPTION OF THE INVENTION

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. In the drawings, the size and relative sizes of layers and regions may be exaggerated for clarity.

It will be understood that when an element or layer is referred to as being “on,” “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numbers refer to like elements throughout. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “lower” relative to other elements or features would then be oriented “upper” the other elements or features. Thus, the term “lower” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments of the invention are described herein with reference to cross-section illustrations that are schematic illustrations of idealized embodiments (and intermediate structures) of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, the present invention will be explained in detail with reference to the accompanying drawings.

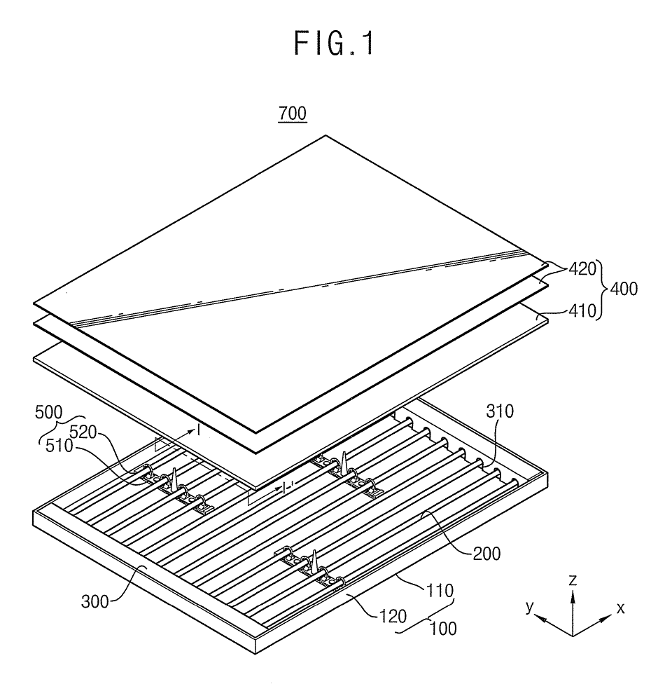

FIG. 1 is an exploded perspective view illustrating an exemplary embodiment of a backlight assembly according to the present invention;

Referring to FIG. 1, a backlight assembly 700 includes a receiving container 100, a lamp 200, a side mold 300, an optical member 400 and a lamp support member 500. The backlight assembly 700 generates light.

In an exemplary embodiment as illustrated in FIG. 1, the backlight assembly may be substantially frame shaped. For orientation purposes, a Cartesian coordinate system may be used where a first side of the backlight assembly extends along a Y-axis direction, and a second side of the display device extends along an X-axis direction, where the Y-axis is substantially perpendicular to the X-axis and a Z-axis direction is substantially perpendicular to both the X and Y axes.

The receiving container 100 includes a bottom portion 110 and a side portion 120 protruding from an edge of the bottom portion 110. The bottom portion 110 and the side portion 120 define a receiving space. The receiving container 100 receives the lamp 200, the side mold 300, the optical member 400 and the lamp support member 500. A fixing hole (not shown) is formed through the bottom portion 110 of the receiving container 100 to be coupled to the lamp support member 500.

The lamp 200 generates light. In exemplary embodiments, the lamp 200 may include a cold cathode fluorescent lamp (CCFL) that has low heat dissipation and long lifetime. The lamp 200 has a substantially rod shape and is elongated along a substantially X-axis (or longitudinal) direction shown in FIG. 1. A plurality of lamps 200 are received in the receiving container 100 and arranged substantially in parallel with each other along a Y-axis direction as shown in FIG. 1.

In alternative exemplary embodiments, the lamp 200 may have a U-rod shape. The lamp 200 may also include an external electrode fluorescent lamp (EEFL) that has an externally disposed electrode.

The lamp 200 is supported by the lamp support member 500 and is spaced apart from the bottom portion 110 of the receiving container 100 by a predetermined distance. The lamp 200 includes a lamp body generating light and an electrode (not shown) receiving a power source.

In an exemplary embodiment, the lamp body has a substantially cylindrical shape. A discharge gas (not shown) is filled in the lamp body and a fluorescent material (not shown) may be formed on an inner surface of the lamp body.

The electrode is disposed at an end portion of the lamp body and particularly disposed inside the end portion of the lamp body. In an alternative exemplary embodiments, when the lamp 200 corresponds to an external electrode fluorescent lamp (EEFL), the electrode of the lamp 200 may be disposed outside the end portion of the lamp body.

The electrode receives the power source from an external inverter (not shown) through a power applying line (not shown). When the power source is applied to the electrode, the electrode generates electrons and the electrons collide with the discharge gas to generate an ultraviolet light (UV). The ultraviolet light is changed into visible light by the fluorescent material and thus the visible light exits the lamp body.

The side mold 300 covers an end portion of the lamp 200. In one exemplary embodiment, two side molds 300 are disposed in the receiving container 100 and face each other. Since the side mold 300 covers the end portion of the lamp 200, the side mold 300 protects the electrode formed at the end portion of the lamp 200. In exemplary embodiments, the side mold 300 has an L-shape, a U-shape, etc. The side mold 300 has a lamp fixing groove 310 that is coupled to the lamp 200 and fixes the lamp 200 to the side mold 300.

The optical member 400 is disposed over the lamp 200 to improve optical characteristics of the light generated from the lamp 200. In an exemplary embodiment, the optical member 400 may include, but is not limited to, a light-diffusing plate 410 and one or more optical sheets 420.

The light-diffusing plate 410 is disposed over the lamp 200 to diffuse the light generated from the lamp 200. In an exemplary embodiment, the light-diffusing plate 410 has a substantially plate shape. The light-diffusing plate 410 may include a synthetic resin capable of diffusing light. In an exemplary embodiment, the light-diffusing plate 410 includes polymethyl methacrylate (PMMA). End portions of the light-diffusing plate 410 are placed on an upper portion of the side mold 300 and a central portion of the light-diffusing plate 410 is supported by a light-diffusing plate support portion of the lamp support member 500.

The optical sheets 420 are disposed on the light-diffusing plate 410 to improve optical characteristics of light passing through the light-diffusing plate 410. The optical sheets 420 may include, but are not limited to, at least one prism sheet enhancing vertical luminance of light by reflection and refraction.

The lamp support member 500 is disposed in the receiving container 100 to support the lamp 200 and the light-diffusing plate 410. The lamp support member 500 includes a support lamp ring 510 and a support plate 520.

The support lamp ring 510 supports the lamp 200 so as to prevent a central portion of the lamp 200 from sagging. The support lamp ring 510 may have a substantial ring shape making relatively small contact with the lamp 200.

The support lamp ring 510 may be ductile to be easily coupled to the support plate 520 and/or may be transparent not to block the light generated from the lamp 200. In an exemplary embodiment, the support lamp ring 510 includes silicon that is ductile and transparent.

The support plate 520 is coupled to the support lamp ring 510 to fix the support lamp ring 510. The support plate 520 is disposed on the bottom portion 110 of the receiving container 100 to be fastened to the receiving container 100. In an exemplary embodiment, the support plate 520 includes a synthetic resin having a great rigidity.

Hereinafter, the lamp support member 500 will be described in detail with reference to the accompanying drawings.

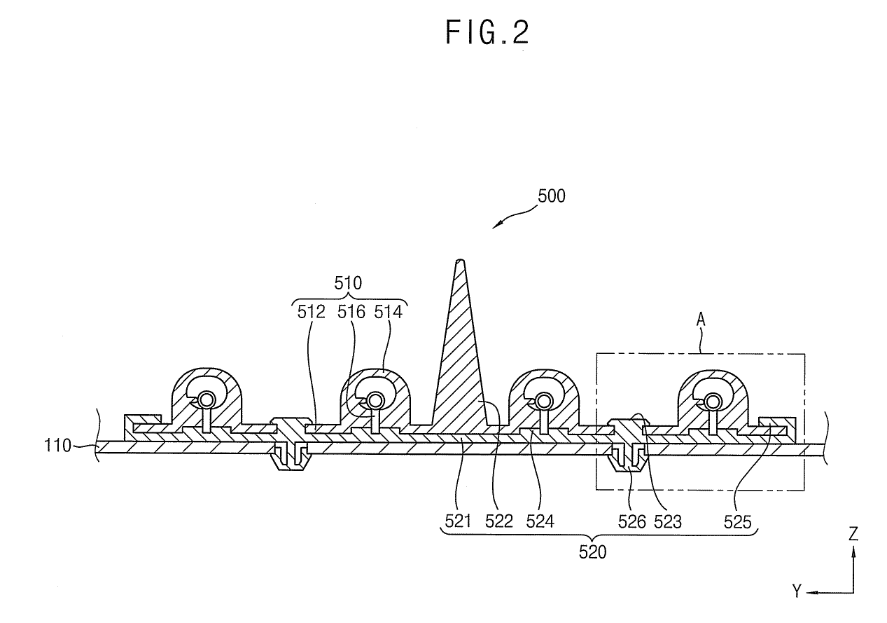

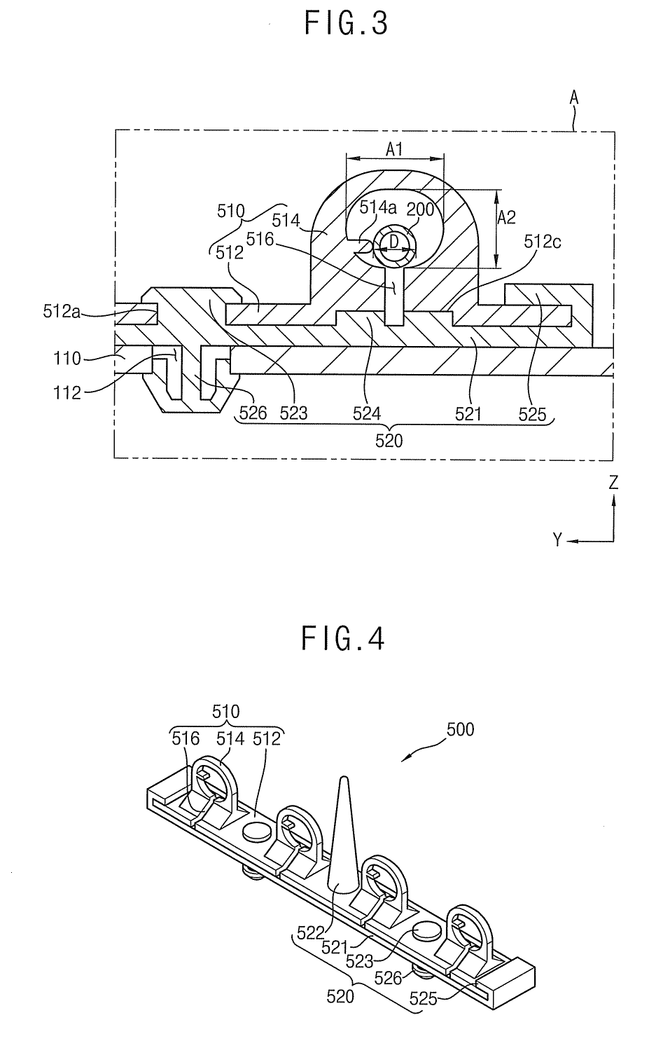

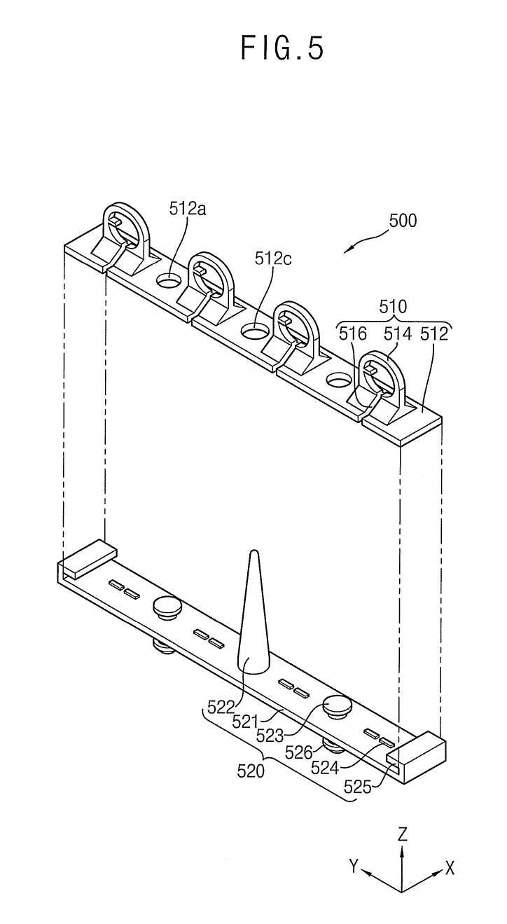

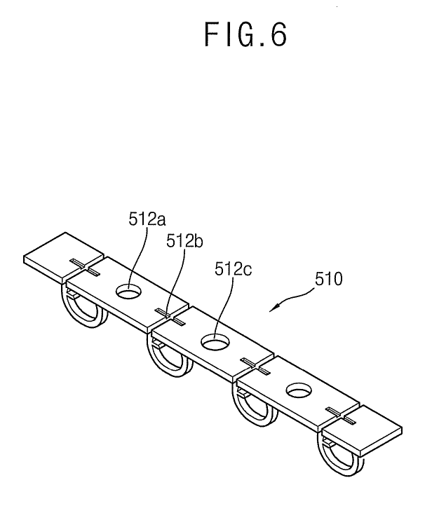

FIG. 2 is a cross-sectional view taken along line I-I′ in FIG. 1. FIG. 3 is an enlarged view of portion ‘A’ in FIG. 2. FIG. 4 is a perspective view illustrating an exemplary embodiment of the lamp support member of the backlight assembly illustrated in FIG. 1. FIG. 5 is an exploded perspective view illustrating the lamp support member illustrated in FIG. 4. FIG. 6 is an exploded perspective view illustrating a rear surface of the support lamp ring of the lamp support member illustrated in FIG. 5.

Referring to FIGS. 2 to 6, the lamp support member 500 includes the support lamp ring 510 and the support plate 520 supporting the lamp 200 and the light-diffusing plate 410.

The support lamp ring 510 supports the lamp 200 so as to prevent the central portion of the lamp 200 from sagging. The support lamp ring 510 includes a lamp ring body portion 512, a lamp ring portion 514 and a slit 516.

Referring to FIG. 6, the lamp ring body portion 512 has a plate shape portion that is relatively long along the Y-axis direction. The lamp ring body portion 512 crosses the lamp 200 in a transverse direction. The lamp ring body portion 512 has a coupling hole 512a, a coupling groove 512b and a light-diffusing plate coupling hole 512c. The coupling hole 512a is coupled to a first coupling protrusion 523 that will be described later, the coupling groove 512b is coupled to a second coupling protrusion 524 that will be described later, and the light-diffusing plate coupling hole 512c is coupled to a light-diffusing plate support portion 522 that will be described later.

A plurality of lamp ring portions 514 protrude from an upper surface of the lamp ring body portion 512. As in the illustrated exemplary embodiment, four lamp ring portions 514 are formed on the lamp ring body portion 512 in FIGS. 2 to 6. The lamp ring portion 514 has substantially a ring shape, and thus the lamp 200 may pass through the lamp ring portion 514 to be supported by the lamp ring portion 514. Referring to FIG. 3, the lamp ring portion 514 has a first inner diameter A1 along a direction substantially in parallel with the bottom portion 110 of the receiving container 100 and a second inner diameter A2 along a direction substantially perpendicular to the bottom portion 110 of the receiving container 100.

In an exemplary embodiment, the first inner diameter A1 may be greater than or equal to the second inner diameter A2. The second inner diameter A2 may be greater than a diameter ‘D’ of the lamp 200. The first inner diameter A1 may be greater than or equal to a sum of the diameter ‘D’ of the lamp 200 and about 1.5 millimeters (mm).

A support protrusion 514a is formed on the lamp ring portion 514. The support protrusion 514a protrudes from an inner side surface of the lamp ring portion 514 in a direction substantially in parallel with the bottom portion 110 of the receiving container 100. An end portion of the support protrusion 514a makes contact with an outer surface of the lamp 200 to support the lamp 200. In an exemplary embodiment, the support protrusion 514a has a protruding length taken in the direction substantially in parallel with the bottom portion 110 in a range of about 0.5 mm to about 1.5 mm. In one exemplary embodiment, the protruding length of the support protrusion 514a may preferably be about 1 mm. The support protrusion 514a of each lamp ring portion 514 protrudes from the lamp ring portion 514 in substantially the same direction. Thus, support protrusion 514a protrudes in a direction counter to the Y-axis direction.

Since the lamp ring portion 514 has a ring shape having a diameter greater than the diameter ‘D’ of the lamp 200, the lamp ring portion 514 may make small contact with the lamp 200. In addition, since the support protrusion 514a is formed on the inner side surface of the lamp ring portion 514, the lamp 200 may be positioned at a central portion of the lamp ring portion 514. In an exemplary embodiment when the backlight assembly 700 is disposed such that the Y-axis direction faces the ground, the lamp 200 may be supported by the support protrusion 514a and thus may be positioned at the central portion of the lamp ring portion 514.

The slit 516 is formed at a lower position of the lamp ring portion 514 to separate the lamp ring portion 514 by a predetermined interval. The lamp ring portion 514 is essentially separated at a lower central position of the inner side surface of the lamp ring portion 514 into two parts to form the slit 516.

The slit 516 partially separates the lamp ring portion 514 into two parts, thereby preventing an externally applied impact from transferring to the lamp 200.

In an exemplary embodiment, the externally applied impact is applied to the support plate 520 of the lamp support member 500 via the bottom portion 110 of the receiving container 100. The impact applied to the support plate 520 transfers to the lamp ring portion 514 of the support lamp ring 510. The impact is ultimately applied to the lamp 200. When the impact is applied to the lamp 200, defects such as a rattle noise may occur in the lamp 200. As in the illustrated embodiment, since the lamp ring portion 514 is partially separated into two parts by the slit 516, the externally applied impact is absorbed in the slit 516, thereby reducing or effectively preventing the impact from transferring to the lamp 200.

The support plate 520 is coupled to the support lamp ring 510 to fix the support lamp ring 510. The support plate 520 includes a plate body portion 521, the light-diffusing plate support portion 522, a plate coupling portion and a fixing protrusion portion 526.

The plate body portion 521 has substantially a plate shape that is relatively long along the Y-axis direction, and is substantially in parallel with the lamp ring body portion 512 to make contact with the lamp ring body portion 512.

The light-diffusing plate support portion 522 protrudes from an upper surface of the plate body portion 521 and supports the light-diffusing plate 410. The light-diffusing plate support portion 522 protrudes at a position of the upper surface of the plate body portion 521, the position being substantially central along the Y-axis direction of the lamp support member 500. In an exemplary embodiment, the light-diffusing plate support portion 522 has substantially a cone shape. The light-diffusing plate support portion 522 is inserted through the light-diffusing plate coupling hole 512c of the lamp ring body portion 512.

The plate coupling portion is formed on the plate body portion 521 to couple the support lamp ring 510 to the support plate 520. The plate coupling portion includes a first coupling protrusion 523, a second coupling protrusion 524 and a coupling link 525.

The first coupling protrusion 523 protrudes from the upper surface of the plate body portion 521 to be coupled to the coupling hole 512a of the lamp ring body portion 512. The first coupling protrusion 523 may be formed at a central position between the lamp ring portions 514.

A head of the first coupling protrusion 523 may be a little larger than a diameter of the coupling hole 512a. Since the support lamp ring 510 may be ductile, the head of the first coupling protrusion 523 may pass through the coupling hole 512a of the lamp ring body portion 512.

When the head of the first coupling protrusion 523 is a little larger than the diameter of the coupling hole 512a, the lamp support 510 may be prevented from being separated from the support plate 520 in a Z-axis direction as shown in FIGS. 2, 3 and 5.

The second coupling protrusion 524 protrudes from the upper surface of the plate body portion 521 to be coupled to the coupling groove 512b (See FIG. 6) of the lamp ring body portion 512. The second coupling protrusion 524 may be formed corresponding to the lamp ring portion 514 in location and/or size of the lamp ring portion 514 on the lamp support member 500. The coupling groove 512b is formed on a lower surface of the lamp ring body portion 512 corresponding to the lamp ring portion 514 and the second coupling protrusion 524 is inserted into the coupling groove 512b.

The coupling link 525 protrudes from an edge of the plate body portion 521. In an exemplary embodiment, the coupling link has substantially a U-shape and an opening of the U-shape faces a center of the plate body portion 521.

The coupling link 525 is coupled to an end of the lamp ring body portion 512 to reduce or essentially prevent the support lamp ring 510 from being separated from the support plate 520. The coupling link 525 prevents the support lamp ring 510 from being separated from the support plate 520 in the Z-axis direction.

The fixing protrusion portion 526 protrudes from the lower surface of the plate body portion 521. The fixing protrusion portion 526 is coupled to a fixing hole 112 formed through the bottom portion 110 of the receiving container 100 so as to fasten the support plate 520 to the receiving container 100.

In an exemplary embodiment, the fixing protrusion portion 526 protrudes from the lower surface of the plate body portion 521 to correspond in location to the first coupling protrusion 523. The fixing protrusion portion 526 may have a space so as to be elastic, and thus the fixing protrusion portion 526 may be easily coupled to the fixing hole 112.

In the illustrated exemplary embodiment, the lamp 200 is partially supported by the lamp ring portion 514a having substantially a ring shape, so that the lamp 200 and the lamp ring portion 514 make relatively small contact with each other, and thus luminance non-uniformity due to decrease in local temperature of the lamp 200 may be reduced or effectively prevented.

In addition, the lamp support member 500 includes the support lamp ring 510 that is ductile and supports the lamp 200 and the support plate 520 that is rigid and coupled to the support lamp ring 510, so that the externally applied impact may be prevented from transferring to the lamp 200.

Furthermore, the lamp ring portion 514 is separated into two parts at the lower position to form the slit 516, so that the externally applied impact may be absorbed in the slit 516 to be prevented from transferring to the lamp 200.

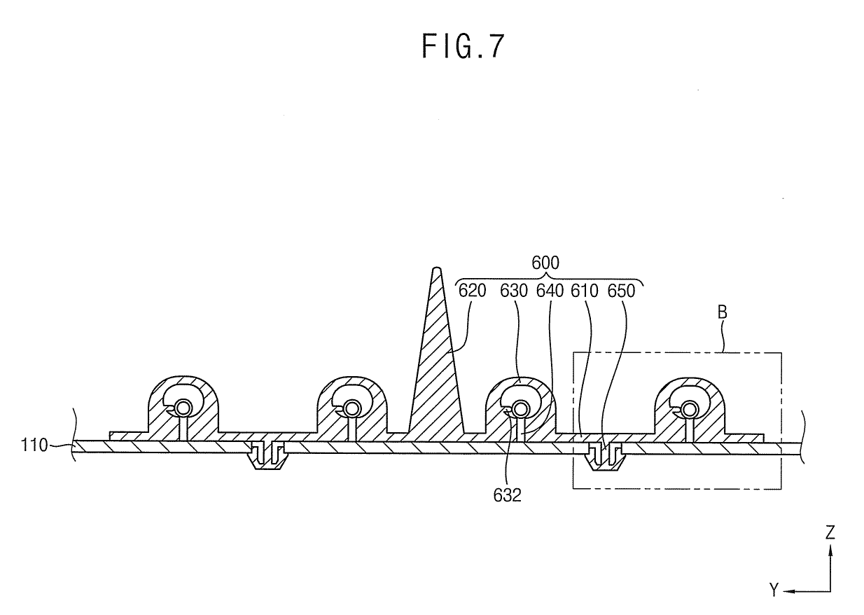

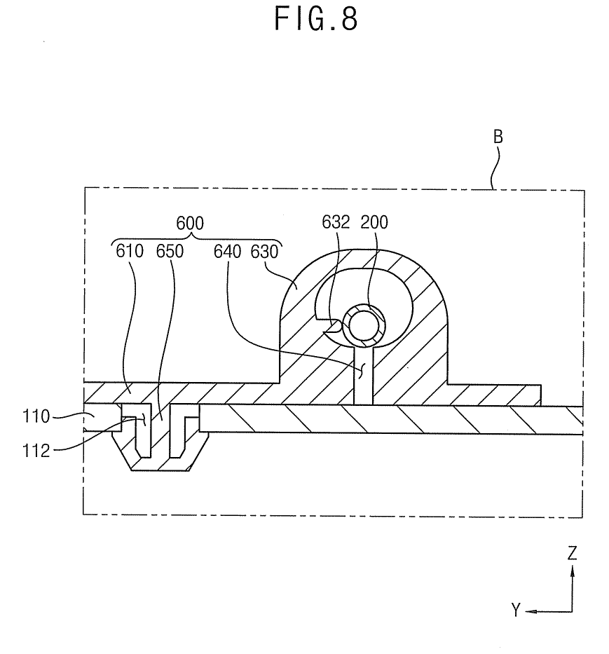

FIG. 7 is a cross-sectional view illustrating another exemplary embodiment of a lamp support member of a backlight assembly according to the present invention. FIG. 8 is an enlarged view of portion ‘B’ in FIG. 7. The backlight assembly of the present embodiment is substantially the same as the backlight assembly of FIGS. 1-6 except for a lamp support member. Thus, any further description will be omitted, and substantially the same elements will be represented by the same reference numerals and the same names.

Referring to FIGS. 7 and 8, a lamp support member 600 includes a support body portion 610, a light-diffusing plate support portion 620, a lamp ring portion 630 and a fixing protrusion portion 650, and has a slit 640. The lamp support member 600 supports the lamp 200 and the light-diffusing plate 410 shown in FIG. 1.

The support body portion 610 has a substantially plate shape, and is disposed on the bottom portion 110 of the receiving container 100. The support body portion 610 extends to cross the lamp 200 in a transverse direction.

The light-diffusing plate support portion 620 protrudes from an upper surface of the support body portion 610 to support the light-diffusing plate 410 shown in FIG. 1. In an exemplary embodiment, the light-diffusing plate support portion 620 protrudes at a position of the upper surface of the support body portion 610, the position being substantially central along the Y-axis direction. The light-diffusing plate support portion 620 has a substantially cone shape.

A plurality of lamp ring portions 630 protrude from the upper surface of the support body portion 610. As in the illustrated exemplary embodiment, four lamp ring portions 630 are formed on the support body portion 610 in FIG. 7. The lamp ring portion 630 has substantially a ring shape, and thus the lamp 200 may pass through the lamp ring portion 630 to be supported by the lamp ring portion 630. The lamp ring portion 630 has a first inner diameter along a direction substantially in parallel with the bottom portion 110 of the receiving container 100 and a second inner diameter along a direction substantially perpendicular to the bottom portion 110 of the receiving container 100.

In an exemplary embodiment, the first inner diameter may be greater than or equal to the second inner diameter. The second inner diameter may be greater than a diameter of the lamp 200. The first inner diameter may be greater than a sum of the diameter of the lamp 200 and about 1.5 mm or substantially equal to the sum of the diameter of the lamp 200 and about 1.5 mm.

A support protrusion 632 is formed on the lamp ring portion 630. The support protrusion 632 protrudes from an inner side surface of the lamp ring portion 630 in a direction substantially in parallel with the bottom portion 110 of the receiving container 100. An end portion of the support protrusion 632 makes contact with an outer surface of the lamp 200 to support the lamp 200. In an exemplary embodiment the support protrusion 632 has a protruding length in a range of about 0.5 mm to about 1.5 mm. In one exemplary embodiment, the protruding length of the support protrusion 632 may preferably be about 1 mm. The support protrusion 632 of each lamp ring portion 630 protrudes from the lamp ring portion 632 in substantially the same direction. Thus, support protrusion 632 protrudes in a direction counter to the Y-axis direction.

The slit 640 is formed at a lower position of the lamp ring portion 630 to separate the lamp ring portion 630 by a predetermined interval. The lamp ring portion 630 is separated or split at a lower central position of the inner side surface of the lamp ring portion 630 into two parts to form the slit 640. The slit 640 partially separates the lamp ring portion 630 into two parts, thereby preventing an externally applied impact from transferring to the lamp 200.

The fixing protrusion portion 650 protrudes from the lower surface of the support body portion 610. The fixing protrusion portion 650 is coupled to the fixing hole 112 formed through the bottom portion 110 of the receiving container 100 so as to fasten the lamp support member 600 to the receiving container 100. In an exemplary embodiment, the fixing protrusion portion 650 protrudes from the lower surface of the support body portion 610 to correspond to a substantially central position between adjacent lamp ring portions 630 in a Y-axis direction.

The lamp support member 600 illustrated in FIGS. 7 and 8 is integrally formed, which is different from the lamp support member 500 in FIGS. 1-6. The lamp support member 600 includes fixing members protruding directly from the support body portion 610 for connecting to the receiving container 100 without using the support plate 520 in FIGS. 1-6. Advantageously, manufacturing cost may decrease and the lamp support member 600 may be easily coupled to and separated from the bottom portion 110 of the receiving container 100.

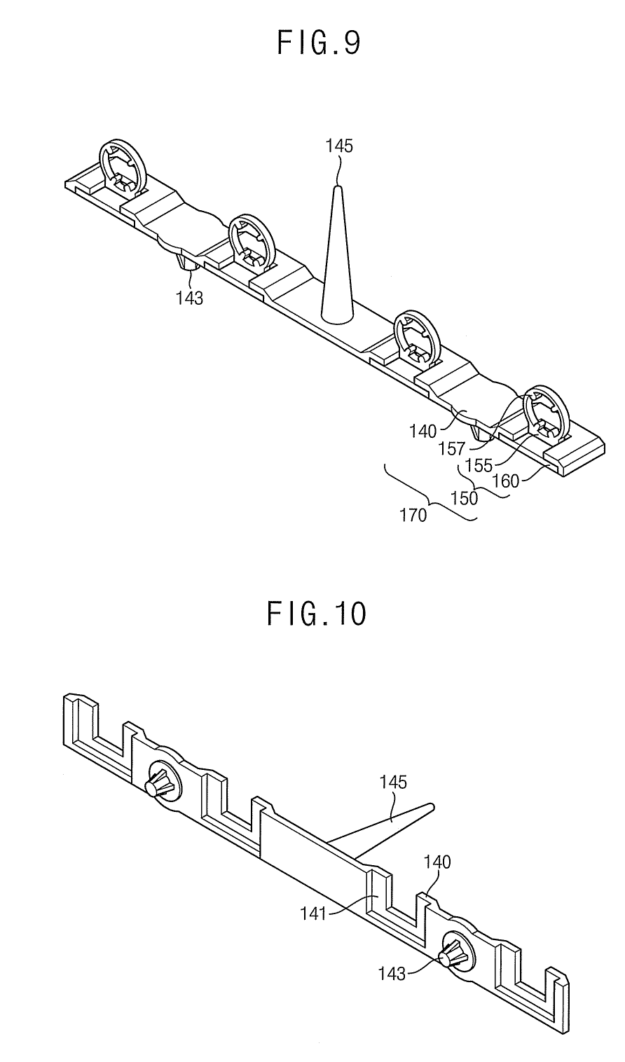

FIG. 9 is a perspective view illustrating another exemplary embodiment of a lamp support member of a backlight assembly according to the present invention. FIG. 10 is a rear perspective view illustrating the support plate illustrated in FIG. 9. The backlight assembly of the present embodiment is substantially the same as the backlight assembly of FIGS. 1-6 except for a lamp support member. Thus, any further description will be omitted.

Referring to FIGS. 9 and 10, a lamp support member includes a support plate 140 and a support lamp ring 150.

The support plate 140 is disposed under a plurality of lamps (not shown) to cross the lamps in a substantially transverse direction. The support plate 140 has, a substantially plate shape that extends in a direction crossing the lamps. A guide groove 141 is formed corresponding to each lamp 200.

A groove is formed on a lower surface of the support plate 140, the groove having a predetermined width and a predetermined depth. The groove extends from a first edge of the support plate 140 toward a second edge of the support plate 140 so as to open the first edge at the lower surface of the support plate 140. An opening is formed above the groove to have a smaller width than the groove. The first edge of the lower surface of the support plate 140 corresponding to the groove is partially open. The second edge of the lower surface of the support plate 140 is closed at portions corresponding to the groove. The guide groove 141 is defined by the groove and the opening. A plurality of guide grooves 141 are formed on the lower surface of the support plate 140 corresponding to the lamps.

Fixing protrusion portions 143 are formed on the lower surface of support plate 140 and between the guide grooves 141. A light-diffusing plate support portion 145 is formed on a central portion of an upper surface of the support plate 140.

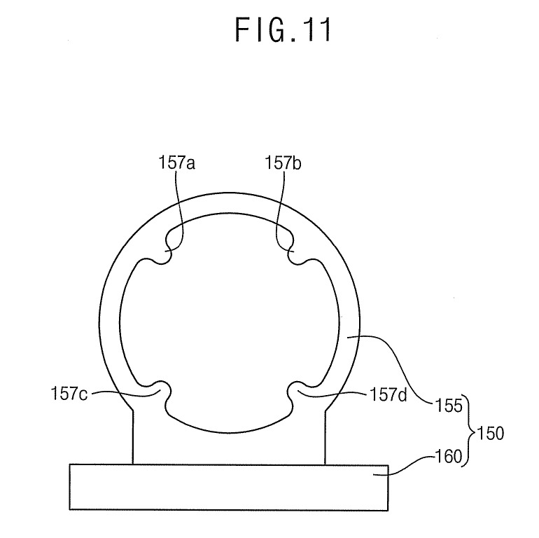

FIG. 11 is a side view illustrating the support lamp ring illustrated in FIG. 9.

Referring to FIG. 11, the support lamp ring 150 includes a lamp ring portion 155 and a lamp ring body portion 160.

The lamp ring portion 155 forms a looped curve and encloses a circumference of the lamp. The lamp ring portion 155 includes fixing protrusions 157 formed on an inner surface of the lamp ring portion 155. In the illustrated exemplary embodiment, 157a, 157b, 157c and 157d The fixing protrusions 157a and 157b are formed at an upper position on the lamp ring portion 155 and the fixing protrusions 157c and 157d are formed at a lower position on the lamp ring portion 155. The fixing protrusions 157a, 157b, 157c and 157d are symmetrically formed. The fixing protrusions 157a, 157b, 157c and 157d are arranged at the same angle relative to the inner surface of the lamp ring portion 155.

The fixing protrusions 157a, 157b, 157c and 157d make contact with an outer surface of the lamp. In an exemplary embodiment, three of the fixing protrusions 157a, 157b, 157c and 157d make contact with the lamp and the other of the fixing protrusions 157a, 157b, 157c and 157d is spaced apart from the outer surface of the lamp so as to prevent damage of the lamp. The other of the fixing protrusions 157a, 157b, 157c and 157d is spaced apart from the outer surface of the lamp, for example, by no more than about 1 mm.

In an exemplary embodiment, order to reduce a contact area between the fixing protrusions 157a, 157b, 157c and 157d and the lamp, a cross-sectional area of each of the fixing protrusions 157a, 157b, 157c and 157d may be gradually smaller from a bottom portion (at the inner surface of the lamp ring 155) to an end portion thereof In exemplary embodiments, each of the fixing protrusions 157a, 157b, 157c and 157d may have substantially a cone shape having round end portions.

The fixing protrusions 157a, 157b, 157c and 157d and the lamp ring portion 155 may include a material having great ductility and optical transmissivity, such as silicon, so as to reduce or effectively prevent damage of the lamp and transmit the light generated from the lamp.

The lamp ring body portion 160 is integrally formed with the lamp ring portion 155 such that the lamp ring body portion 160 and with the lamp ring portion 155 form a single continuous member. The lamp ring body portion 160 is coupled to the guide groove 141 formed on the support plate 140. The lamp ring body portion 160 has a substantially rectangular shape corresponding to the guide groove 141. In exemplary embodiments, the lamp ring body portion 160 may have any of a number of shapes or dimensions corresponding to the guide groove 141 and facilitating removable insertion of the lamp ring body portion 160.

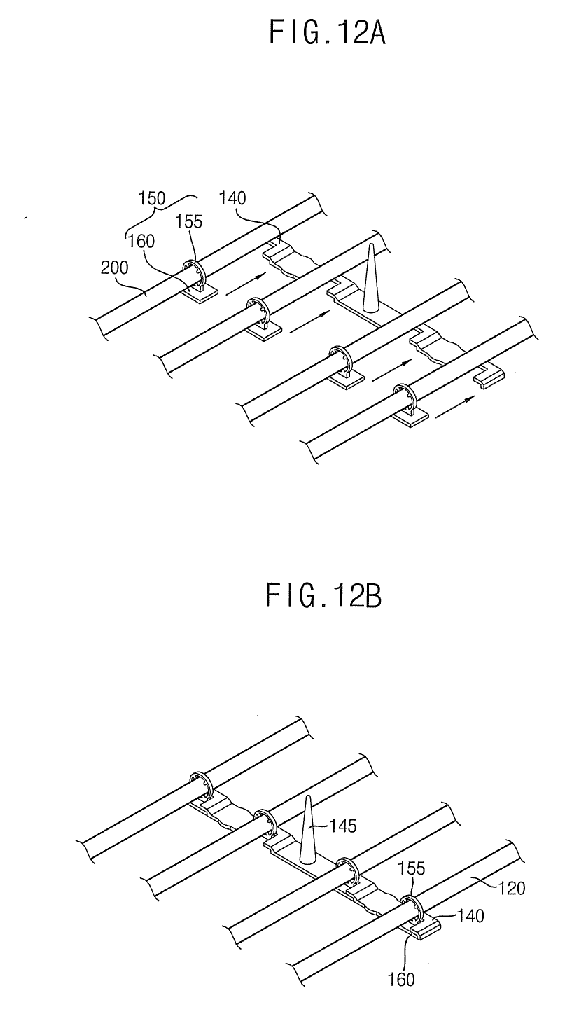

FIG. 12A and FIG. 12B are perspective views illustrating an exemplary embodiment of a method of coupling the support plate and the support lamp ring illustrated in FIG. 9.

Referring to FIG. 12A, the lamp 200 is inserted through the lamp ring portion 155. The lamp ring body portion 160 integrally formed with the lamp ring portion 155 slides along the guide groove 141 formed on the support plate 140 to be inserted into the guide groove 141 as shown by the arrows. The lamp ring portion 155 is partially exposed through the opening of the guide groove 141 in a Z-axis direction, or in a direction away from an upper surface of the support plate 140.

Contact surfaces between the guide groove 141 and the lamp ring body portion 160 may have increased surface roughness so that the lamp ring body portion 160 may not be separated from the guide groove 141 in a direction counter to the insertion direction. In an exemplary embodiment, the lower surface of the support plate 140 corresponding to the guide groove 141 (such as at the opening) and the upper surface of the lamp ring body portion 160 may be treated so as to have an increased coefficient of friction.

As in the illustrated exemplary embodiment, the fixing protrusions 157a, 157b, 157c and 157d are formed on the lamp ring portion 155 along the circumference of the lamp, making contact with the lamp, thereby reducing or effectively preventing drift of the lamp in various directions. Advantageously, luminance non-uniformity of the light from the backlight assembly in accordance with positions of the lamp may be reduced or effectively prevented.

In addition, the fixing protrusions 157a, 157b, 157c and 157d reduce the contact area between the lamp and the lamp ring portion 155 and reduce heat transfer from the lamp to the lamp ring portion 155. Advantageously, a dark portion that may be incurred from bias of mercury in the lamp due to decrease in temperature of the contact area may decrease.

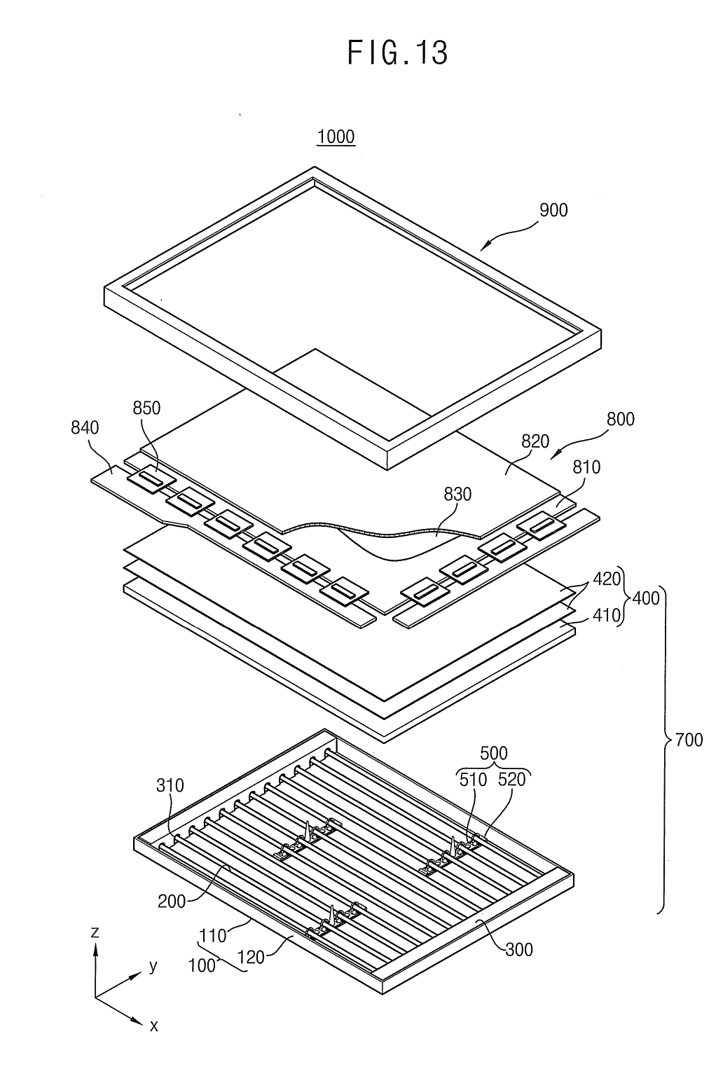

FIG. 13 is an exploded perspective view illustrating an exemplary embodiment of a display device according to the present invention. The backlight assembly included in the display device as in the illustrated exemplary embodiments is substantially the same as the backlight assembly according to FIGS. 1-12. Thus, any further description will be omitted, and substantially the same elements will be represented by the same reference numerals and the same names.

Referring to FIG. 13, a display device 1000 includes a backlight assembly 700, a display panel 800 and a top chassis 900. The display device 1000 externally displays images using light.

The display panel 800 is disposed over the backlight assembly 700 and converts light generated from the backlight assembly 700 into image light having information. The display panel 800 includes a first substrate 810, a second substrate 820, a liquid crystal layer 830, a printed circuit board (PCB) 840 and a flexible circuit board 850.

The first substrate 810 includes a plurality of pixel electrodes arranged in a matrix shape, a plurality of thin film transistors (TFTs) each applying a driving voltage to the pixel electrodes and a plurality of signal lines each applying a signal to the TFTs.

In an exemplary embodiment, a transparent conductive material such as indium tin oxide (ITO) film, indium zinc oxide (IZO) film, amorphous indium tin oxide (a-ITO) film, etc. may be patterned through photolithography process to form the pixel electrodes.

The second substrate 820 faces the first substrate 810. The second substrate 820 includes a common electrode that is disposed on the second substrate 820 and is transparent and conductive, and a plurality of color filters facing the pixel electrodes.

In an exemplary embodiment, the color filters may include a red color filter selectively transmitting red light of white light, a green color filter selectively transmitting green light of white light, and a blue color filter selectively transmitting blue light of white light.

The liquid crystal layer 830 is interposed between the first substrate 810 and the second substrate 820 and is rearranged by an electric field between the pixel electrodes and the common electrode. The rearranged liquid crystal layer 830 adjusts an optical transmissivity of the light generated from the backlight assembly 700. After the light passes through the liquid crystal layer 830, the light also passes through the color filters to display images.

The PCB 840 includes a driving circuit unit (not shown) processing an image signal and converting the externally applied image signal into the driving signal controlling the TFTs.

The PCB 840 may include a data PCB and a gate PCB. The flexible circuit board 850 is bent to place the data PCB on a side surface or a rear surface of the receiving container 100. Another flexible circuit board 850 is bent to place the gate PCB on the side surface or the rear surface of the receiving container 100. In exemplary embodiments, the gate PCB may be removed by forming signal lines on the first substrate 810 and the flexible circuit board 850.

The flexible circuit board 850 electrically connects the PCB 840 and the first substrate 810, thereby providing the driving signal from the PCB 840 to the first substrate 810. In an exemplary embodiment, the flexible circuit board 850 includes tape carrier package (TCP) or chip on film (COF).

The top chassis 900 encloses edge portions of the display panel 800 and is combined with the side portion 120 of the receiving container 100 to fasten the display panel 800 to the backlight assembly 7000. The top chassis 900 protects the display panel 800 from breakage and damage due to externally applied impact and vibration and reduces or effectively prevents separation of the display panel 800 from the receiving container 100.

In the illustrated exemplary embodiment, the lamp may be partially supported by the lamp support member having a ring shape, so that the lamp and the lamp support member make relatively small contact with each other. Advantageously, luminance non-uniformity due to decrease in local temperature of the lamp may be reduced or effectively prevented.

Also, the lamp support member may include two parts such as the support lamp ring that is ductile and supports the lamp and the support plate that is rigid and coupled to the support lamp ring. Advantageously, transfer of the externally applied impact to the lamp may be reduced or effectively prevented.

In addition, the lamp ring portion may be separated into two parts at the lower position to form the slit, so that the externally applied impact may be absorbed in the slit to be prevented from transferring to the lamp.

Furthermore, when the lamp support member is integrally formed, not including a two-parts structure, but a single unit type, manufacturing costs may decrease. Advantageously, the lamp support member may be easily coupled to and separated from the bottom portion of the receiving container, thereby improving work efficiency.

Although example embodiments of the present invention have been described, it is understood that the present invention should not be limited to these example embodiments but various changes and modifications can be made by one ordinary skilled in the art within the spirit and scope of the present invention as hereinafter claimed.

What is claimed is:

1. A backlight assembly comprising:
a receiving container comprising a bottom portion and a side portion defining a receiving space;
a plurality of lamps arranged substantially in parallel with each other in the receiving container and generating light; and
a lamp support member disposed in the receiving container, the lamp support member comprising a support lamp ring supporting a lamp of the plurality of lamps and a support plate coupled to the support lamp ring and fixing the support lamp ring.

2. The backlight assembly of claim 1, wherein the support lamp ring comprises:
a lamp ring body portion crossing the lamp; and
a lamp ring portion protruding from the lamp ring body portion and having a ring shape enclosing the lamp.

3. The backlight assembly of claim 2, wherein the support lamp ring further comprises a slit at a lower position of the lamp ring portion, the slit separating the lamp ring portion by a predetermined interval.

4. The backlight assembly of claim 2, wherein the lamp ring portion has a first inner diameter along a direction substantially in parallel with the lamp ring body portion and a second inner diameter along a direction substantially perpendicular to the lamp ring body portion, the first inner diameter being greater than or equal to the second inner diameter.

5. The backlight assembly of claim 4, wherein the second inner diameter is greater than a diameter of the lamp.

6. The backlight assembly of claim 4, wherein the first inner diameter is greater than or equal to a sum of a diameter of the lamp and about 1.5 millimeters (mm).

7. The backlight assembly of claim 2, wherein the support lamp ring further comprises a support protrusion protruding from an inner surface of the lamp ring portion in a direction substantially in parallel with the lamp ring body portion, the support protrusion supporting the lamp.

8. The backlight assembly of claim 7, wherein the support protrusion has a protruding length in a range of about 0.5 mm to about 1.5 mm.

9. The backlight assembly of claim 7, wherein the support lamp ring further comprises a plurality of lamp ring portions, the support protrusion of each support lamp ring protruding from the lamp ring portion in substantially the same direction.

10. The backlight assembly of claim 2, wherein the support plate comprises:
a plate body portion disposed substantially in parallel with the lamp ring body portion and making contact with the lamp ring body portion; and
a plate coupling portion disposed on an upper surface of the plate body portion and coupling the plate body portion to the support lamp ring.

11. The backlight assembly of claim 10, wherein the plate coupling portion comprises a coupling link protruding from an edge of the plate body portion and coupled to an end of the lamp ring body portion.

12. The backlight assembly of claim 11, wherein the coupling link has a U-shape.

13. The backlight assembly of claim 10, wherein the lamp ring body portion comprises a coupling hole and a coupling groove, and the plate coupling portion comprises a first coupling protrusion coupled to the coupling hole and a second coupling protrusion inserted into the coupling groove.

14. The backlight assembly of claim 13, wherein the second coupling protrusion corresponds to the lamp ring portion.

15. The backlight assembly of claim 10, wherein the support plate further comprises a fixing protrusion portion protruding from a lower surface of the plate body portion, the fixing protrusion portion being coupled to the bottom portion of the receiving container so as to fasten the support plate to the receiving container.

16. The backlight assembly of claim 10, further comprising a light-diffusing plate disposed over the lamps and diffusing the light generated from the lamps, wherein the support plate further comprises a light-diffusing plate support portion protruding from the upper surface of the plate body portion and supporting the light-diffusing plate.

17. The backlight assembly of claim 1, wherein the support lamp ring is ductile.

18. The backlight assembly of claim 1, wherein the support lamp ring is transparent.

19. The backlight assembly of claim 1, wherein the support lamp ring includes silicon.

20. The backlight assembly of claim 1, wherein the support plate comprises a guide groove and the support lamp ring is inserted into the guide groove.

21. The backlight assembly of claim 20, wherein the support lamp ring comprises:
a lamp ring portion comprising a plurality of fixing protrusions arranged along an inner periphery of the lamp ring portion, the fixing protrusions making contact with the lamp; and
a lamp ring body portion integrally formed with the lamp ring portion and inserted into the guide groove, the lamp ring portion and the lamp ring body portion being a single unit.

22. The backlight assembly of claim 21, wherein the guide groove extends from a first edge of the support plate toward a second edge of the support plate and the lamp ring body portion is inserted from the first edge along a longitudinal direction of the lamp and is coupled to the guide groove.

23. The backlight assembly of claim 21, wherein the fixing protrusions protrude in a direction substantially perpendicular to a longitudinal direction of the lamp.

24. A backlight assembly comprising:
a receiving container comprising a bottom portion and a side portion defining a receiving space;
a plurality of lamps arranged substantially in parallel with each other in the receiving container and generating light; and
a lamp support member disposed in the receiving container, the lamp support member comprising a support body portion crossing the plurality of lamps and a lamp ring portion protruding from the support body portion and having a ring shape enclosing the lamp.

25. The backlight assembly of claim 24, wherein the lamp support member further comprises a support protrusion protruding from an inner surface of the lamp ring portion in a direction substantially in parallel with the bottom portion of the receiving container, the support protrusion supporting the lamp.

26. The backlight assembly of claim 24, wherein the lamp support member further comprises a slit formed at a lower position of the lamp ring portion, the slit separating the lamp ring portion by a predetermined interval.

27. The backlight assembly of claim 24, wherein the lamp support member further comprises a fixing protrusion portion protruding from a lower surface of the support body portion, the fixing protrusion portion being coupled to the bottom portion of the receiving container so as to fasten the lamp support member to the receiving container.

28. The backlight assembly of claim 24, further comprising a light-diffusing plate disposed over the lamps and diffusing the light generated from the lamps, wherein the lamp support member further comprises a light-diffusing plate support portion protruding from an upper surface of the support body portion and supporting the light-diffusing plate.

29. A display device comprising:
a backlight assembly comprising:
a receiving container comprising a bottom portion and a side portion defining a receiving space;
a plurality of lamps arranged substantially in parallel with each other and disposed over the bottom portion of the receiving container, the plurality of lamps generating light; and
a lamp support member coupled to the bottom portion of the receiving container and fixing the lamps, the lamp support member comprising a support lamp ring enclosing and supporting the lamp and a support plate coupled to the support lamp ring and fixing the support lamp ring; and
a display panel disposed over the backlight assembly and displaying images using the light provided from the backlight assembly.
